(19) United States
(12) Patent Application Publication
(10) Pub. No.: US 2011/0045821 A1
(43) Pub. Date: Feb. 24, 2011

(54) SAMPLING AND REPORTING PERFORMANCE OF A COMMUNICATION NETWORK

(75) Inventors: Oliver P. Tyce, Swindon (GB); Chris M. Murphy, Bath (GB)

Correspondence Address: MOTOROLA MOBILITY, INC, 600 NORTH US HIGHWAY 45, W2-55BB, LIBERTYVILLE, IL, 60048-5343, US

(73) Assignee: MOTOROLA, INC., Schaumburg, IL (US)

(21) Appl. No.: 12/559,531

(22) Filed: Sep. 15, 2009

Related U.S. Application Data
(60) Provisional application No. 61/236,166, filed on Aug. 24, 2009.

(51) Int. Cl. H04W 24/00

(52) U.S. Cl. 455/424

(57) ABSTRACT

An apparatus and method for sampling and reporting performance of a communication network includes a first step 200 of defining reporting probability-based rules for sampling and reporting network performance measurements. A next step 202 includes providing the rules to a plurality of mobile stations attached to the network. A next step 204 includes sampling network measurements by the mobile stations in accordance with the rules. A next step 206 includes reporting the network performance measurements to the network in accordance with the rules.

### FIELD OF THE INVENTION

The present invention relates generally to radio communications and, in particular, to sampling and reporting performance of a communication network.

### BACKGROUND OF THE INVENTION

In 4G communication systems, such as the Long Term Evolution (LTE) and Worldwide Interoperability for Microwave Access (WiMAX) communication systems, it is important to optimise network performance for users in any location. The actual network diagnostic and optimisation metrics for measuring network performance can include Received Signal Strength Indicator (RSSI), Carrier-To-Interference-and-Noise Ratio (CINR), throughput, and the like, as are known in the art. Past techniques for measuring network performance (i.e. a drive test) has involved an independent measuring entity that actual travels around various locations of the network to detect any zones with little or no coverage or other problem areas. However, in 4G communication systems this mechanism is limited since many coverage areas can be very small, e.g. solely within a building. It is also and impractical due to the time and expense involved.

Subscriber devices such as user equipment (UE) or mobile stations (MS) offer a unique view of a cellular network. They perform measurements as part of routine operations such as radio resource management and mobility management. These and other measurements made by the MS, if transmitted by the MS and collected centrally by the network, can be a rich source of data for understanding and optimising network performance. For example, each MS in the network can measure and collect network benchmark or diagnostic metrics. These values are then collected from the MSs via a simple system of interrogation messages from a management server. As larger volumes of data are collected from subscriber devices, a more accurate picture of the network is available to be used as the basis of optimisation activities. However, with this comes increased costs in the form of additional servers necessary to collect such data and the increased cellular messaging and resources necessary to transport such data. Data collection then risks becoming part of the problem by significantly degrading network performance through congestion. Furthermore, this client-server based approach comprises unicast messaging to manage the reporting or polling of such data, which can have scalability problems. For example, a server facilitating the management of network performance by controlling devices will want on one hand to maximise the value of the data it collects by increasing the data volume, but on the other hand it will want to minimise the number of transactions it will have to perform to control the data generation.

The value attached to the data held at each device will vary by factors such as its location, the performance problems it is experiencing and the intended use of measurement data. Ideally the set of data to collect from each device would be individually adjusted based upon the utility or value attached to the data. However, this introduces the problem that at least part of the data must be sent from the device to the network before its value can be assessed. This also compounds the complexity and scalability issues for the collection servers, as their role of possibly soliciting and then collecting reported data must be extended to allow the value of collected data to be assessed and decisions made about whether additional data should be queried from each individual device.

An alternative to collecting part of the data and assessing its value is to configure triggering criteria in a subscriber device. If these criteria are met the device will transmit a measurement to the server. Such triggers can include location, radio conditions, or mobility events. Moreover, the binary nature of such triggering criteria is constraining in use cases where more control over data sampling is necessary. In addition, fine-tuning of the collection of measurements using the unicast control approach can have serious limitations. Since the collection cannot be controlled in real time, extreme caution must be exercised in configuring the collection. If it is configured in such a way that certain network conditions cause excessive volumes of subscriber data to be generated, there may not be time to generate a multitude of unicast messages to reconfigure the collection and “stem the flow” in time to avoid the network being brought to its knees.

For these reasons, data collection can degenerate into a conservative compromise. The set of data to collect, the subset of devices to collect these data from, and the rate at which to collect such data become limited by the uplink bandwidth, server resources that are available and the need to avoid conditions where the messages containing the data congest the network.

One approach to resolve these problems is for the network carrier to directly communicate with MS to gather measurements from the MSs via a specialised agent in the MS. In this case, control commands to each MS is via unicast messaging, and triggering of measurements is via simple network events, radio conditions, etc, with all the associated limitations. Moreover, the above approach does not specifically address the problem of controlling the volumes of data or targeting the data to specific problems in real time.

The real-time issue can be addressed by deferring latency-tolerant transmissions from a subscriber device in cases when the network is congested. While this would offer some relief to the problem of congestion caused by conveying data for optimisation, it is only sidestepping the problem and does not permit either correction of problems or control of collection in substantially real-time in response to conditions of degraded network performance.

Another approach is to collect measurements at a user device and transmit these measurements to a server or similar for optimisation purposes. This approach uses a policy-based mechanism with measurements triggered by network events giving a means to manage selectively which mobile stations are to serve as test mobiles. This approach also limits transmissions of measurement data in cases of high cell load, low available power, etc, and stores measurements for later transmission when the conditions are better suited to transmission. While this has the potential to target the collection and tune the measurement data to high-value optimisation activities, there is still a dependence on unicast messaging between the collection server and the MS. This will compound any congestion problems in the network and will make real-time reactive measures difficult to implement.

What is needed is a technique that mitigates the above problems.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 illustrates an example of a communication network in accordance with the present invention; and

FIG. 2 illustrates an example of a method, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DETAILED DESCRIPTION OF EMBODIMENTS OF THE INVENTION

The present invention overcomes the limitations of unicast messages by specifying a technique for transmitting information to all devices (or groups of devices) that allows the devices to assess the usefulness and value of the data that they hold and derive a probability that controls whether their data should be reported to the network manager based on that value. By introducing reporting probabilities, sampling and resource usage can be controlled at a finer level of detail than existing methods.

By deviating from the previous unicast techniques and/or providing a novel triggering mechanism, the value of collected data may be increased while reducing the volumes of data that need to be transmitted. At the same time the mechanism for delivering the data from devices is unaffected. Furthermore, the substantially real-time nature in which the transmitted information can be updated, allows the volume and type of data collected from all devices to be updated rapidly in response to changes in the purpose of the data collection, the availability or scarcity of spare bandwidth, properties of the collected data, or other criteria. By broadcasting control information, control over the reporting of all devices is achieved in near real-time, i.e. the maximum latency is equivalent to the periodicity of the transmitted messages. In contrast, to achieve similar low latencies using the prior art unicast control techniques would requires a plethora of messages to be sent in a very short space of time, which in many circumstances would induce so much congestion as to have a catastrophic impact on the normal network traffic.

The following description focuses on embodiments of the invention applicable to 4G communication systems such as LTE and WiMAX. For example, the present invention can be implemented for LTE evolved NodeBs (eNB). The present invention could also be applied to the WiMAX base stations. However, it will be appreciated that the invention is not limited to these applications but may be applied to many other cellular communication systems such as a 3GPP (Third Generation Partnership Project) E-UTRA (Evolutionary UMTS Terrestrial Radio Access) standard, a 3GPP2 (Third Generation Partnership Project 2) Evolution communication system, a CDMA (Code Division Multiple Access) 2000 1XEV-DO communication system, a Wireless Local Area Network (WLAN) communication system as described by any of the IEEE (Institute of Electrical and Electronics Engineers) 802.xx standards, for example, the 802.11a/HiperLAN2, 802.11g, 802.16, or 802.21 standards, or any of multiple other proposed ultrawideband (UWB) communication systems. Therefore, as used herein the term eNB can also represent a base station, access point, NodeB, or other similar device. In addition the term mobile station can also represent a user equipment, subscriber station, access terminal, computer, personal digital assistant, or any other communication terminal.

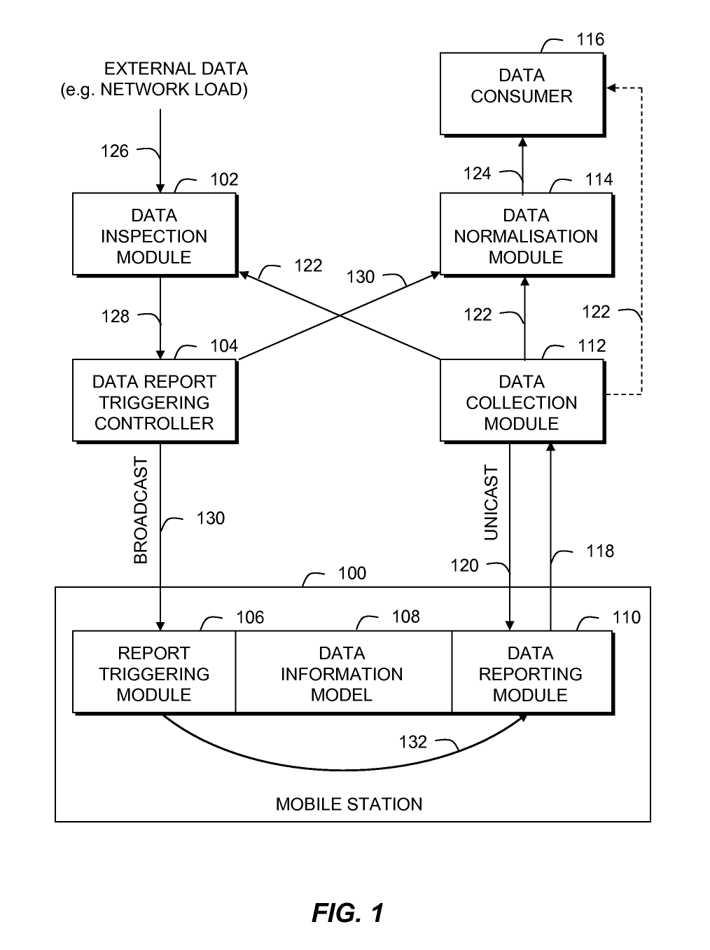

FIG. 1 shows a communication network in accordance with the present invention. The connections between nodes are shown for a typical implementation, although other implementations are possible. A Data Consumer 116 is a function that receives reported measurement data from one or more mobile stations 100 and uses these for network optimisation. For example, the Data Consumer 116 can be an engineer trying to diagnose a problem in the network or can be a program for network optimisation in a network management entity, such as a Mobility.Management Entity. A Data Collection Module 112 provides a function that collects measurement data from mobile stations. The collection manner may vary, so a server may receive 118 reported data or actively query 120 the device, via a unicast message, for measurement data. The actual reporting mechanism can take various active or passive forms. Preferably, when a rule is triggered and the reporting probability evaluated, the mobile would immediately “push” its measurement to the Data Collection Module 112 without any prompting therefrom. In another example, the mobile would “push” its measurement to the Data Collection Module 112 at a time when the load on the network falls below some threshold. In another example, the Data Collection Module 112 periodically polls the mobile station, which can indicate whether it has data to report. In yet another example, the Data Collection Module 112 can actively query the mobile station for any data it might have.

A Data Report Triggering Controller 104 transmits (e.g. broadcasts) control information 122 or rules that encapsulate the conditions under which mobile stations 100 should sample and report their measurement data. Examples of these rules and their use are presented below.

A Report Triggering Module 106 comprises a transceiver and processor 106-110 of a mobile station 100 and uses the transmitted reporting control information 122 to determine when the reporting criteria have been met and data reporting 118 should be initiated. A Data Reporting Module 110 also resides in the transceiver and processor on the mobile station 100 and reports measurement data 118 to the Data Collection Module 112. The Report Triggering Module 106 can control 132 the Data Reporting Module 110 to either actively report data to the Data Collection Module 112, or passively offer its data when the Data Collection Module 112 next polls it for data.

A Data Normalisation Module 114 can be an optional Data Consumer that normalises collected measurement data 122 from the Data Collection Module 112 to account for the reporting probability-based sampling that was in place (broadcast 130) at the time of the data collection. Alternatively, the collected data 122 from the Data Collection Module 112 can be provided directly to the Data Consumer 116. A Data Inspection Module 102 is an optional Data Consumer that inspects collected data 122 and external data 126 (e.g. network load) in real time and alters the Data Report Triggering Controller 104 in order to maximise the utility of the collected information and/or maintain acceptable usage of the server, air interface, and backhaul resources. It should be recognized that one or more of the Data Inspection Module 102, Data Report Triggering Controller 104, Data Collection Module 112, Data Normalisation Module 114, and even the Data Consumer 116 can all be part of the same network entity, such as an eNB or network management entity that includes a processor and transceiver for implementing the present invention.

The present invention operates under the control of a network management entity such as the Data Report Triggering Controller 104. This will cause triggering messages 130 to be transmitted periodically to mobile devices 100 in the network. The level of integration of the Data Report Triggering Controller 104 with the cellular network will determine the flexibility available in terms of the mobile station group(s) to which transmitted messages can be restricted. These messages 130 contain one or more rules that mobile stations 100 can use to determine what measurements they should perform and when to communicate these measurements to the Data Collection Module 112. Each rule comprises the following: a) a Boolean expression that represents the triggering of the rule when a condition is met. This would typically be encoded using the existing data elements of a device Data Information Model 108 appropriate for that technology, and which can be extended with constants and simple logical, relational and arithmetic operators, b) an associated reporting probability, that further controls whether data is reported when the condition is met, and c) a set of data that should be collected (or reported) if the condition is met. The structure of the Data Information Model 108 varies by technology and is defined for more efficient collection and network optimisation. The Data Information Model 108 uses the predefined technology conventions (i.e. for LTE or WiMAX for example) to encode the data that can be collected, so that the present invention can re-use this schema of “available measurements” to define the triggers.

A novel aspect of the present invention is broadcasting control messages to all devices or groups of devices, rather than in a unicast fashion to single devices, to improve scalability and responsiveness. Another novel aspect of the present invention is the reporting probability-based sampling which allows a valuable means to control the sampling for data collection, the value of which is illustrated in the examples below.

### EXAMPLE 1

### Real Time Trouble Shooting

In this example, a customer reports that their network throughput has been poor recently. A reasonable approach to investigating this is to confirm whether the throughput is indeed lower than expected for that user (rather than the cause being a rogue application that is consuming the available bandwidth for instance) and whether the problem is specific to that user or common to other users in the same sector. When investigating the problem, the signal level/quality and serving cell of the customer is determined and an engineer generates a data collection message (i.e. rules) to be broadcast to identify other devices on the same cell with a similar signal.
Trigger rule: if ((device->rf_information->serving_cell->cid==“231421”) && (device->rf_information->serving_cell->rssi>=−86) && (device->rf_information->serving_cell->rssi<=−82) && (device->rf_information->serving_cell->cinr>=12) && (device->rf_information->serving_cell->cinr<=15))
Reporting probability: 0.5
Reported quantities: device->rf_information→serving_cell->rssi device->rf_information->serving_cell->cinr device->ip_information->throughput
   In this example, the trigger rule includes a Boolean expression that is encoded using the data elements of; serving cell identification (cid), received signal strength indicator (rssi), and carrier-to-interference-and-noise ratio (cinr). In this case the engineer wants to measure parameters of cell number 231421. The conditions to be met in this cell are whether the rssi falls between −86 dbm and −82 dbm and the cinr falls between 12 db and 15 db. If all these conditions are met then sampling of measurement data can be done by the mobile station. The rules also include a reporting probability. The mobile station compares this reporting probability against a zero-to-one random number generator in its processor. If the random number generator provides a number that is less than or equal to the probability, then the mobile station can report its sampled measurements. In this case the rules also specify which measurements to report, which includes not only rssi and cinr, but also throughput. These measurements are reported by the mobile station without any prompting by the network (i.e. the measurements are actively “pushed” by the mobile station). With the probability of 0.5, the network will only receive reports from about 50% of the mobile stations attached to cell 231421 which meet the rssi and cinr criteria, which saves network capacity, while providing a representative sample of measurements.

It should be noted that it is not necessary to include the serving_cell->cid in the above message in the case that the control message is broadcast on only the serving cell of interest. The probability of reporting can be set reasonably high for this message, as it has a limited scope and the data reported is low volume. This allows the engineer to quickly ascertain whether the user is getting low throughput compared to similar users in the same cell. Depending upon the results, the engineer could then investigate further by requesting similar information from users in a broader area to see whether the customer's achieved throughput is lower than users in other sectors. Alternatively, the engineer could request more detailed statistics to determine why throughput is low (e.g. ARQ retransmission rate, HARQ retransmission rate, etc.) using the same targeted mechanism facilitated by the present invention.

### EXAMPLE 2

### Capacity and Coverage Optimisation

In this example, RF information may be captured for optimising transmission power and/or antenna tilt/azimuths. This might be in any wideband system with high frequency reuse. In the case of systems with soft handoff (such as CDMA or UMTS), the optimisation method is based upon constructing and solving a model of the required transmission power of all users under different network configurations. To build the model, the signal quality of all detectable sectors for each user with an active call is required. In the case that no soft handoff is used (such as LTE or WiMAX), the goal is simply to minimise inter-cell interference while maintaining (or even improving) coverage. Both of these cases can be achieved using a model of the radio network based on the data collected from the actual subscribers. Although the constructed model must be representative of the whole user population, the optimisation results are far more sensitive to the completeness of the model with respect to users who are in RF conditions where they detect multiple sectors at a similar signal level. The reason for this is that even small configuration changes may have a large effect on the soft handover state or level of interference that such users receive, whereas only very major configuration changes have a significant effect on users receiving a single dominant signal. In this case, a limited value of optimisation would be gained from the data reported by the majority of users (i.e. the approximately 70% of users those not in soft handover or significant cell overlap). Hence, for a radio access technology that supports soft handover, the collection could more intelligently be set up in the following manner, for example:
Trigger rule: if (device->soft_handover state->total_connections=1)
Reporting probability: 0.1
Reported quantities: device->rf_information->serving_cell->rssi device->rf_information->serving_cell->cinr device->rf_information->measured_cell->rssi device->rf_information->measured_cell->cinr
and
Trigger rule: if(device->soft_handover_state->total_connections>1)
Reporting probability: 1.0
Reported quantities: device->rf_information->serving_cell->rssi device->rf_information->serving_cell->cinr device->rf_information->measured_cell->rssi device->rf_information->measured_cell->cinr
   In this example, the two trigger rules includes a Boolean expression that is encoded using the data element of soft handover state. The conditions to be met in the first rule is whether a user is only connected to a single sector (i.e. is not in soft handover). In this first case only ten percent (i.e. probability 0.1) of the users will report their serving cell rssi and cinr and their potential handover cell rssi and cinr measurements. The condition to be met in the second rule is whether a user is connected to multiple sectors (i.e. is in soft handover). In this second case all users (i.e. probability 1.0) are asked to report their serving cell rssi and cinr and their potential handover cells rssi and cinr measurements.

The data collection is thereby weighted towards users in soft handover. When building the optimisation model, a corrective weighting can be attached to the data points that normalises the data based upon this asymmetric sampling. Only one in ten users with a single connection would have reported their data, therefore all data points in the model that are based upon such users would have a relative weighting in the model that is ten times greater than those data points based upon users with multiple connections. The Data Normalisation Module 114 is responsible for assessing how data collected should be weighted, based upon the triggering criteria 130 that were in place during the collection.

### EXAMPLE 3

### Real Time Sampling Adjustment

In this example, optimisation problems such as frequency planning can be time-consuming to run as they may involve searching for a solution in a large candidate solution space. However, the utility of data collected for solving complex optimisation problems can often be assessed in nearly real time. Furthermore, the resources that are available for collecting such data with minimal network impact can often be assessed in real time. Hence, a data collection targeted towards users experiencing poor RF conditions could sensibly be initiated with a low sampling rate:
Trigger rule: if (device->rf_information->serving_cell->cinr<=5)∥(device->rf_information->serving_cell->rssi<=−92)
Reporting probability: 0.1
Reported quantities: device->rf_information->serving_cell->cinr device->rf_information->serving_cell->rssi
   In this example, the trigger rule includes a Boolean expression that is encoded using the data elements of; received signal strength indicator (rssi), and carrier-to-interference-and-noise ratio (cinr). The conditions to be met in this cell are whether the rssi falls below—92 dbm or the cinr falls below 5 db, whereupon the mobile stations can report their serving cell cinr and rssi. With the probability of 0.1, the network will only receive reports from about 10% of the mobile stations operating under these poor channel conditions.

In real-time, the volume of data collected from each sector and the amount of free capacity on each sector could be assessed by the Data Inspection Module 102 and the rules adjusted, so that more specific reporting criteria could be iteratively defined. For example, an under represented (or lightly loaded) sector may have the thresholds and/or reporting probability increased:
Trigger rule: if (device->rf_information->serving_cell->cid==“231421”) && ((device->rf_information->serving_cell->cinr<=8) ∥(device->rf_information->serving_cell->rssi<=−87))
Reporting probability: 0.2
Reported quantities: device->rf_information->serving_cell->cinr device->rf_information->serving_cell->rssi
   While, an over represented (or heavily loaded) sector may have the thresholds and/or reporting probability decreased:
Trigger rule: if (device->rf_information->serving_cell->cid==“231422”) && ((device->rf_information->serving_cell->cinr<=2) ∥(device->rf_information->serving_cell->rssi<=−97))
Reporting probability: 0.05
Reported quantities: device->rf_information->serving_cell->cinr device->rf_information->serving_cell->rssi

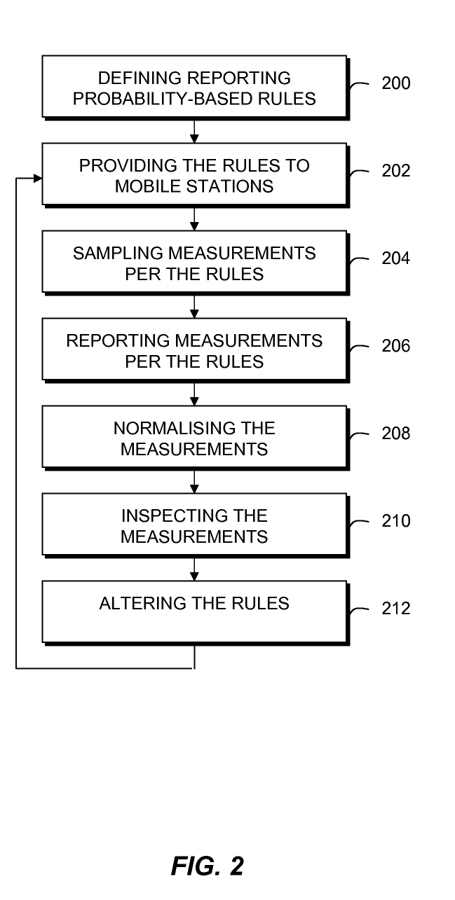

FIG. 2 illustrates a method for sampling and reporting performance of a wireless or wireline communication network in accordance with the present invention. The method includes a first step 200 of defining reporting probability-based rules for sampling and reporting network performance measurements. These rules include conditions to be met under which a mobile station should sample network measurements, particular conditions to be sampled, and a reporting probability to trigger reporting of those network measurements to the network. Specifically, the rules include a Boolean expression that represents the triggering of the rule when a condition is met. The rules include a set of measurements that should be sampled when the condition is met. The rules can also include an associated reporting probability that controls whether data is reported when the condition is met. The Boolean expression is encoded using existing data elements of a device data model appropriate for the network technology. Optionally, the Boolean expression can be extended with at least one of the group of; constants, logical operators, relational operators, and arithmetic operators.

A next step 202 includes providing the rules to a plurality of mobile stations attached to the network. In one embodiment, the providing step can be accomplished with a transmission such as a unicast, broadcast, or any other transmitted control mechanism. Preferably, the transmission is a broadcast, which can be sent periodically. In another embodiment, the rules can be provided by hard coding the rules in the mobile stations instead of, or in addition to, being transmitted. Optionally, the providing step is restricted to particular defined groups of mobile stations.

A next step 204 includes sampling network performance measurements by the mobile stations in accordance with the rules.

A next step 206 includes reporting the network performance measurements to the network in accordance with the rules.

A next step 208 includes normalising the network measurements in response to the reporting probability-based sampling that was in place at the time of the measurements.

A next step 210 includes inspecting the measurements in substantially real-time.

A next step 212 includes altering the rules to maintain network resources. Using periodic transmitting ensures that these adjustments are delivered to the mobile stations in a timely manner. Alternatively, a rule adjustment can trigger an immediate new transmission of the adjusted rules.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for sampling and reporting performance of a communication network, the method comprising the steps of:
defining reporting probability-based rules for sampling and reporting network performance measurements;
providing the rules to a plurality of mobile stations attached to the network;
sampling network performance measurements by the mobile stations in accordance with the rules; and
reporting the network performance measurements to the network in accordance with the rules.

2. The method of claim 1, wherein the reporting probability-based rules include conditions under which a mobile station should sample network measurements and triggers for reporting those network measurements to the network.

3. The method of claim 1, further comprising the step of:
normalising the network measurements in response to the reporting probability-based sampling that was in place at the time of the measurements.

4. The method of claim 1, further comprising the steps of:
inspecting the measurements in substantially real-time, and
altering the rules to maintain network resources.

5. The method of claim 1, wherein the providing step includes transmitting the rules periodically.

6. The method of claim 1, wherein the providing step is restricted to defined groups of mobile stations.

7. The method of claim 1, wherein the rules include a Boolean expression that represents the triggering of the rule when a condition is met.

8. The method of claim 7, wherein the rules include a set of measurements that should be sampled when the condition is met.

9. The method of claim 8, wherein the rules include an associated reporting probability that controls whether data is reported when the condition is met.

10. The method of claim 7, wherein the Boolean expression is encoded using existing data elements of a device data model appropriate for the network technology.

11. The method of claim 10, wherein the Boolean expression is extended with at least one of the group of constants, logical operators, relational operators, and arithmetic operators.

12. The method of claim 1, wherein the providing step includes broadcasting the rules.

13. The method of claim 1, wherein the providing step includes hard coding the rules in the mobile stations.

14. A mobile station for sampling and reporting performance of a communication network, the mobile station comprising:
a transceiver operable to sample and report network performance measurements; and
a processor coupled to the transceiver, the processor operable to obtain the sampled network performance measurements by the transceiver in accordance with provided reporting probability-based rules, and direct the transceiver to report the network performance measurements to the network in accordance with the reporting probability-based rules.

15. A network management entity for the sampling and reporting of communication network performance, the entity comprising:
a transceiver operable to receive network performance measurements sampled by the mobile stations in accordance with provided reporting probability-based rules and reported by the mobile stations in accordance with the reporting probability-based rules; and
a processor coupled to the transceiver, the processor operable to obtain the sampled and reported network performance measurements from the transceiver.
